(19) United States
(12) Patent Application Publication
(10) Pub. No.: US 2010/0185342 A1
(43) Pub. Date: Jul. 22, 2010

(54) Autonomous Water Craft

(76) Inventor: Roy H. Wubker, JR., Palm Beach Gardens, FL (US)

Correspondence Address: MCHALE & SLAVIN, P.A., 2855 PGA BLVD, PALM BEACH GARDENS, FL, 33410, US

(21) Appl. No.: 12/577,873

(22) Filed: Oct. 13, 2009

Related U.S. Application Data
(60) Provisional application No. 61/104,938, filed on Oct. 13, 2008.

(51) Int. Cl. G05D 1/00

(52) U.S. Cl. 701/2

(57) ABSTRACT

The present invention is a control module which can communicate with an autopilot control system of a marine vessel and enable an individual or other device to remotely control the marine vessel. The control module can communicate wirelessly with a lap top computer, a PDA, a computer connected to the Internet or other types of control devices which are capable of controlling a marine vessel. The control module can also be in communication with preprogrammed navigation software which communicates with and operates an onboard marine autopilot system. A satellite phone can also transmit navigation commands to the control module via a sat com communication modem connected to the control module.

### CROSS REFERENCE TO RELATED APPLICATIONS

This application claims the benefit under 35 U.S.C. 119(e) of U.S. Provisional Patent Application No. 61/104,938, filed Oct. 13, 2008, entitled, “AUTONOMOUS WATER CRAFT”, the entirety of which is incorporated herein by reference.

### FIELD OF THE INVENTION

The present invention relates generally to monitoring and control systems and in particular to monitoring and control systems for a marine vessel or watercraft.

### BACKGROUND OF THE INVENTION

Many marine vessels include commercial-off-the-shelf auto pilot navigation systems, such as those manufactured by Raymarine®. These systems enable almost anyone with various levels of skill to properly control and navigate marine vessels. Depending on the number of controls and level of complexity, the auto pilot navigation system can control any function of the vessel from a simple control of the throttle to a complete navigation control of the vessel. Many marine vessels are controlled by simple remote control (RC) devices. However, these devices provide only one way communication with the marine vessel and do not enable complex or real time navigation of the marine vessel.

### DESCRIPTION OF THE PRIOR ART

U.S. Pat. No. 5,961,560 issued to Kemner discloses a system and method for managing a fleet of mobile machines. The system identifies the location of individual machines and controls the navigation of all of the machines to achieve the desired services.

U.S. Pat. No. 7,096,811 issued to Clarke et al. discloses a method and system for the control and delivery of commercial containers ashore without the container terminals.

U.S. Pat. No. 6,273,771 issued to Buckley et al. discloses a control system for a marine vessel which incorporates a CAN Kingdom network to control the vessel.

U.S. Published Patent Application No. 2005/0209746, filed by Kish et al. discloses a system for monitoring and controlling marine vessels and watercraft.

### SUMMARY OF THE INVENTION

The present invention is a control module which can communicate with an autopilot control system of a marine vessel and enable an individual or other device to remotely control the marine vessel. The control module can communicate wirelessly with a lap top computer, a PDA, a computer connected to the Internet or other types of control devices which are capable of controlling a marine vessel. The control module can also be in communication with preprogrammed navigation software which communicates with and operates an onboard marine autopilot system. A satellite phone can also transmit navigation commands to the control module via a sat corn communication modem connected to the control module.

Accordingly, it is an objective of the instant invention to provide a control module which can communicate with an autopilot control system of a marine vessel and enable an individual or other device to remotely control the marine vessel.

It is a further objective of the instant invention to provide a control module which can readily be connected to any commercial-off-the-shelf marine autopilot system and enable remote control of the vessel.

It is a still a further objective of the instant invention to provide a control module which can readily be connected to any commercial-off-the-shelf marine autopilot system and enable wireless line of sight remote control of the vessel.

It is yet another objective of the instant invention to provide a control module which can readily be connected to any commercial-off-the-shelf marine autopilot system and enable remote control of the vessel via satellite phone.

It is a still further objective of the invention to provide a control module which can be connected to a commercial-off-the-shelf navigation auto pilot system of a marine vessel and control the vessel from any location on the earth.

Other objects and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is a schematic of an embodiment of the control module and related components of the present invention;

FIG. 2 is another embodiment of the invention illustrated in FIG. 1;

FIG. 3 is another embodiment of the invention illustrated in FIG. 1;

FIG. 4 is a marine vessel which incorporated the navigation and control system of the present invention;

FIG. 5 is a side view of a container which houses the control module of the present invention and further illustrates how it is connected to a marine vessel and

FIG. 6 is front view of the container which houses the control module of the present invention illustrated in FIG. 5.

### DETAILED DESCRIPTION OF THE INVENTION

While the present invention is susceptible of embodiment in various forms, there is shown in the drawings and will hereinafter be described a presently preferred, albeit not limiting, embodiment with the understanding that the present disclosure is to be considered an exemplification of the present invention and is not intended to limit the invention to the specific embodiments illustrated. In all the drawing figures, similar elements are identified by the same reference numeral.

Commercial-off-the-shelf (COTS) marine autopilot systems are sold widely by retailers to the general boating public. These systems generally cost less than $10,000.00 and employ the global positioning system (GPS) for waypoint navigation via user specified position inputs on a manual interface unit or personal computer (PC) with appropriate mapping software installed. Given a known reference position of the vessel, the user can plot a simple waypoint course or heading into the autopilot unit where a rate sensor gyro senses vessel orientation/acceleration and automatically computes a continuous solution that makes necessary control inputs at the helm to stay on the desired course. Throttle, generally, is not a programmable or controllable feature for these autopilot systems, and accordingly, manned operation of the vessel and oversight is assumed at all times by the autopilot manufacturer. Because these systems are widely sold, the consumer benefits from a volume-induced reduced cost per unit. The invention is an embedded system that augments the COTS autopilot capability by transforming it into a truly remote control and/or autonomous vessel piloting system for unmanned surface vessel (USV) applications and the like that are typically prone to high cost, low production volume, vessel development program-specific control systems that are usually funded under government programs.

Since these COTS autopilot systems accept GPS position inputs via a direct user interface, the invention replaces that direct connection with wireless digital modems which can include both line-of-sight (LOS) and beyond-line-of-sight (BLOS) modems, such as satellite telephones, or a combination of both. In this way, a control station console position can be situated in a location other than that of the vessel being controlled. Simple waypoint navigation programs developed at the base station control console using the autopilot provider's or other compatible mapping software are sent wirelessly to the vessel with the invention installed for the on-board COTS autopilot to execute. The wireless modem on-board the vessel is connected to the module of the invention which, in turn is connected to the COTS autopilot, a GPS receiver, and a throttle linear actuator or servo at a minimum. Navigation programs can be sent wirelessly to the invention or pre-programmed prior to disembarkation on removable storage media that can be read by the invention for program execution. Desired throttle settings during execution of a specific navigation program can be controlled wirelessly and tied to specific GPS waypoints, headings or time intervals in the program. Real-time or near real-time wireless GPS reporting to the base station control console from the vessel being controlled allows for calculation of speed and heading as wells as program execution monitoring. New programs can be sent wirelessly at anytime from the base control station while the vessel is underway if an altered course is desired.

Wireless manual remote control of the vessel via LOS and BLOS modems is also possible with the invention. In this remote manual control mode, the linear actuators or servos driving the helm and throttle on board the vessel accept instantaneous control or command inputs from a remote helm and throttle located at the base control console not unlike a model radio control (RC) boat. The autopilot can be engaged and disengaged at will by a plurality of users situated at a plurality of base station control console locations at any time given an authentication code and hand-off between users. In this way, one base control console situated at a BLOS location can be monitoring a programmed waypoint course it sent to a specific vessel via a satellite modem, then when within range of another user at a known location within LOS range of the vessel, autopilot control is switched off by that user and manual control taken for a period, then set back on autopilot and handed-off to the first user or another user, and so on.

The invention also serves as the primary storage and wireless data flow through-put device to send data from the vessel to the user at the base control station. The module of the invention provides ports for connection to external data gathering devices as well as storage space for data in the form of removable storage media. Many of these external data gathering devices could be those typically available as part of COTS bridge suites for the general boating public that include, but not limited to, radar, sonar and the like.

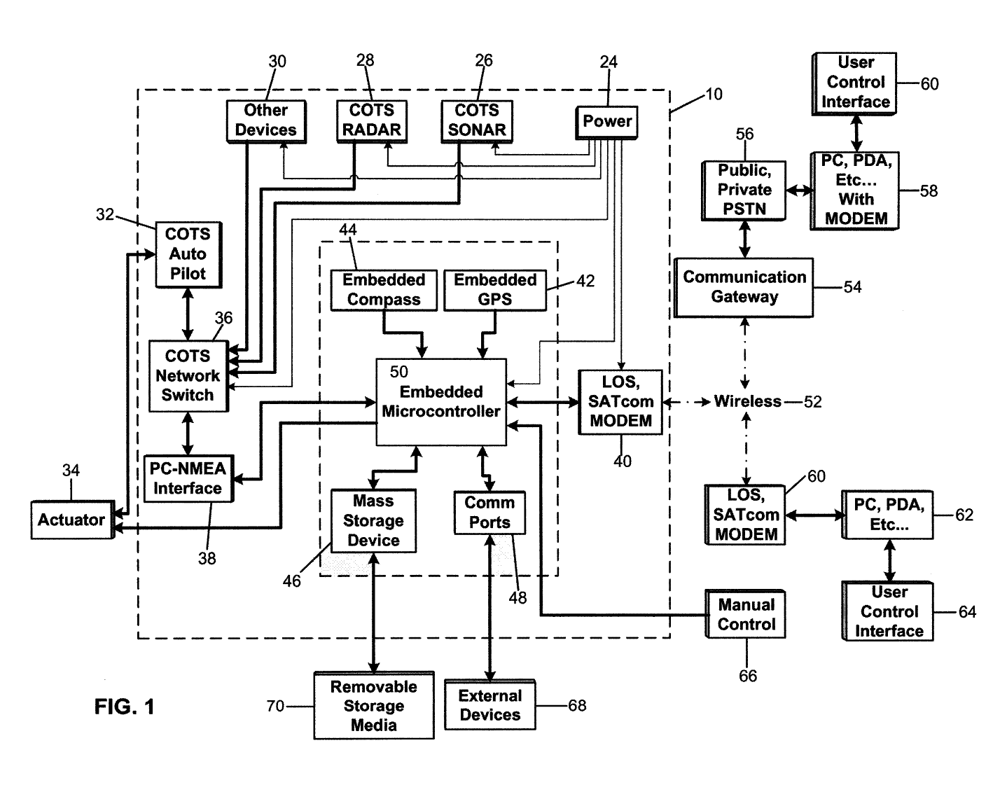

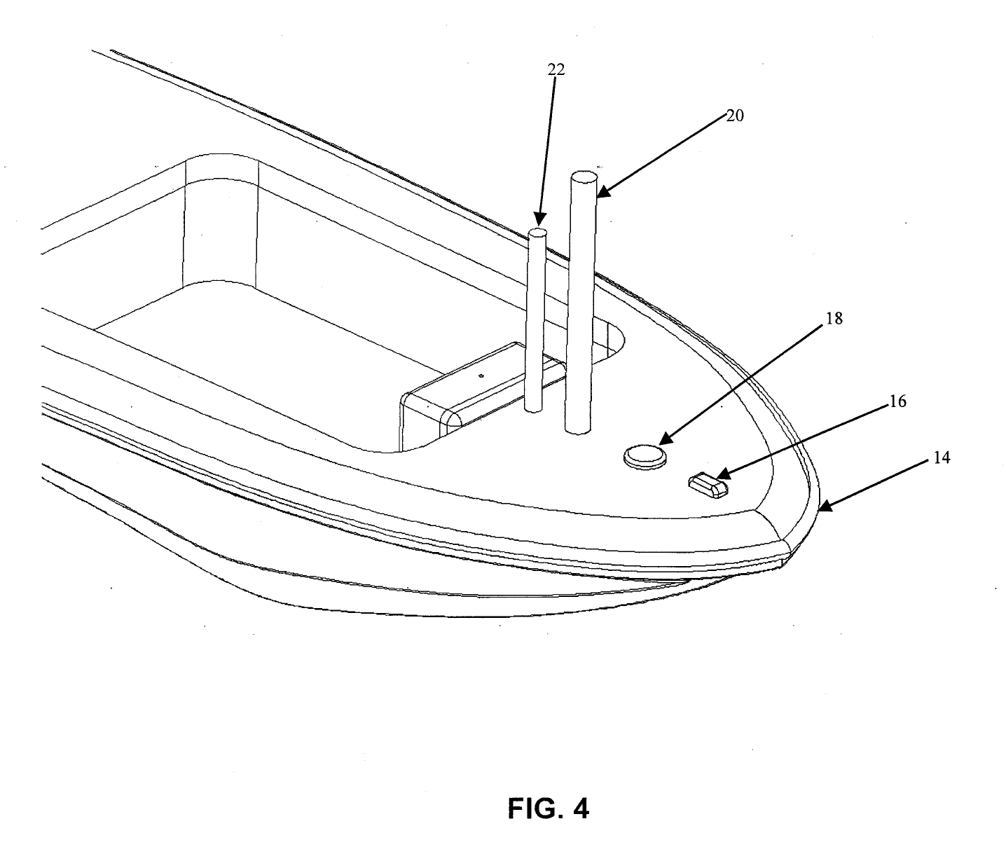

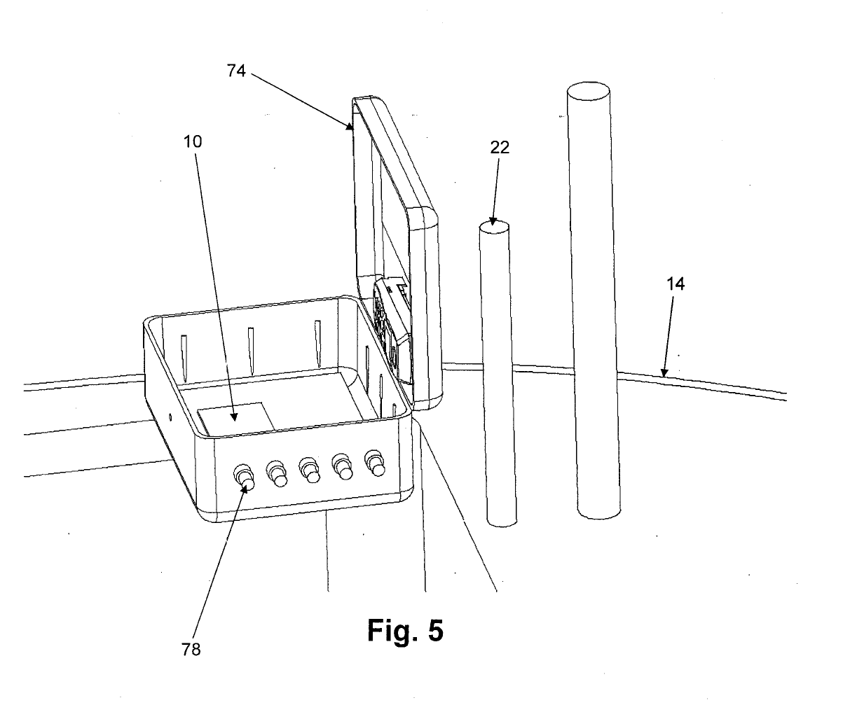

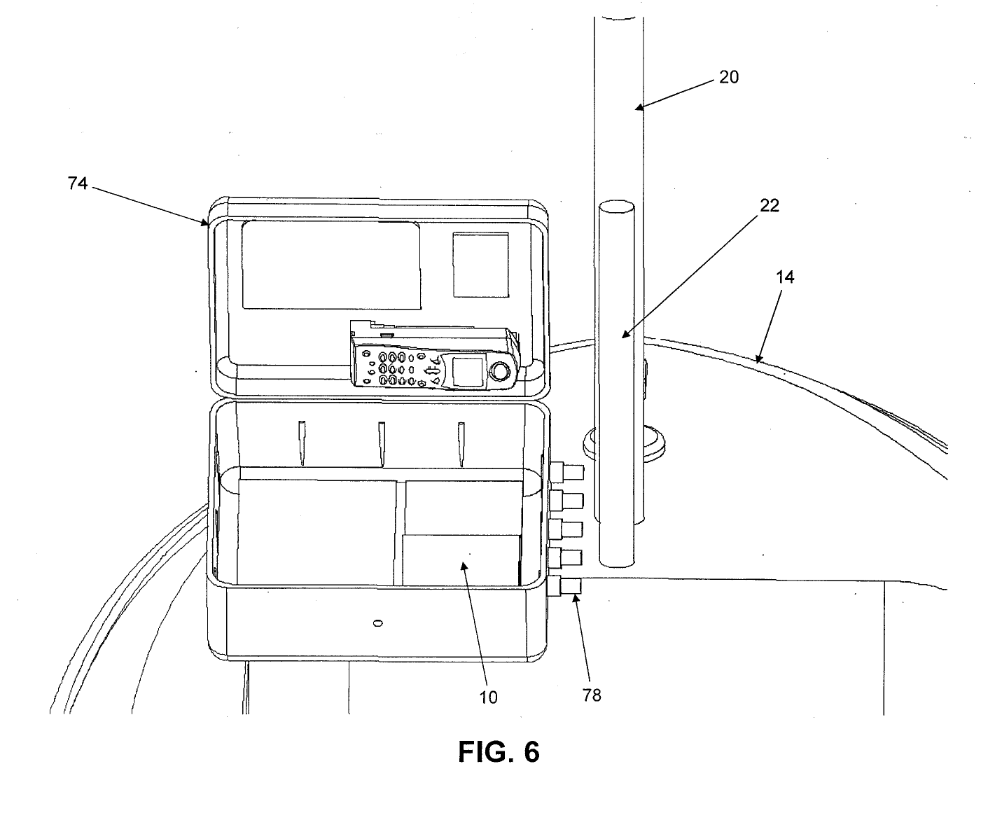

Referring to FIGS. 1-6 of the drawings the present invention includes a control module 10 which can readily be connected to and removed from marine autopilot systems of vessels. The control module 10 is identified by the dashed line square in FIGS. 1-3 and also the hinged box in FIGS. 5 and 6. The marine vessel which is controlled by the present invention is illustrated as boat 14 in FIG. 4. The boat 14 includes a plurality of signal reception devices thereon. A GPS receiver 16 is secured to a forward portion of the boat on the top side thereof. An Iridium satellite phone antenna 18 secured toward a center portion of the boat to communications via satellite phone. An L-band antenna 20 is secured toward a center portion of the boat to permit communications in the L-band range of the frequency band. An S-band antenna 22 is secured toward a center portion of the boat and permits communication in the S-band of the frequency range. S-band is also used in optical communications. While these antennae are illustrated in their preferred mounting positions, they can be placed anywhere on the boat or vessel as long as they can provide communication between the boat and an individual or other devices located remote of the boat. An antenna can also be provided to enable ZigBee communications of commands. While most of the communication systems are line of sight (LOS) a satellite phone system such as the one provided by Iridium can also provide SAT corn communication to the control module 10.

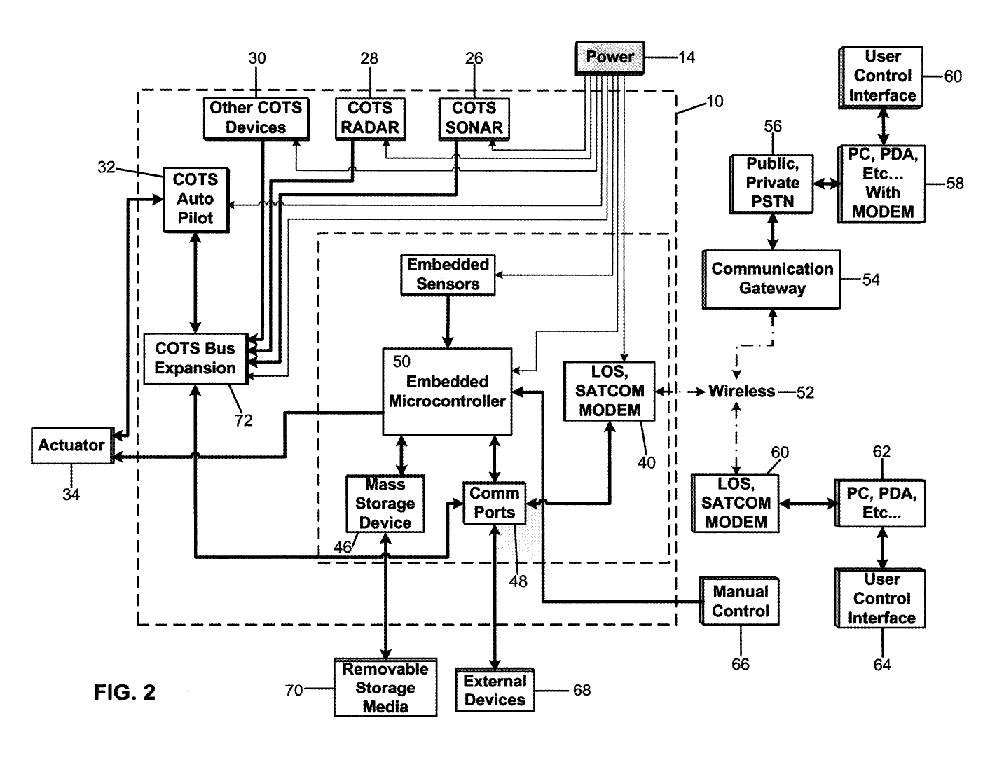

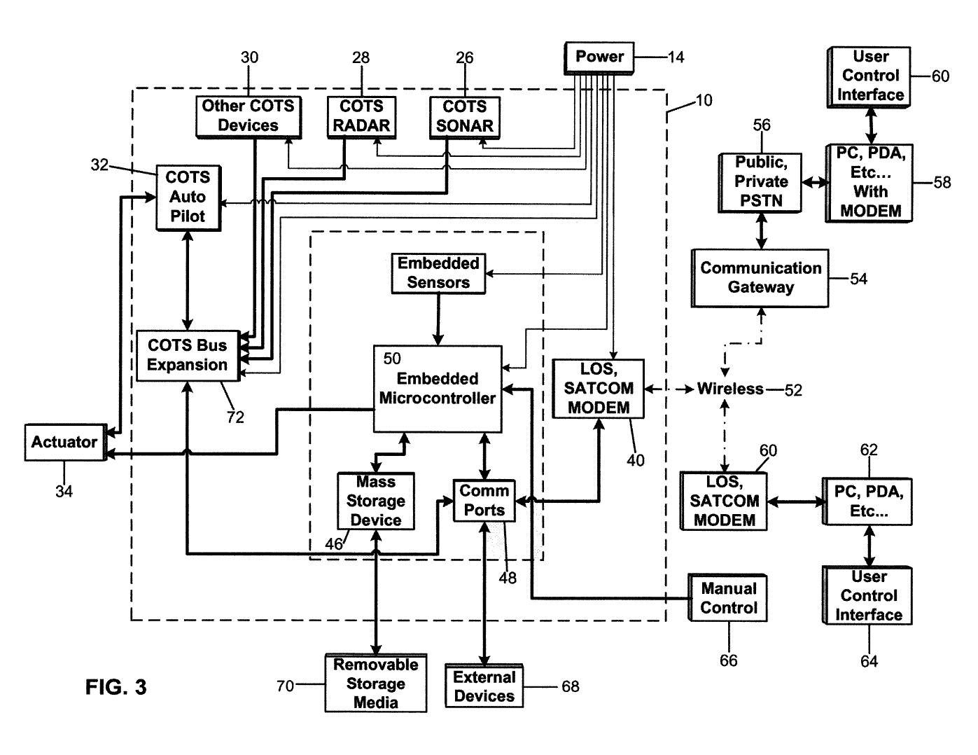

The module 10 of the present invention includes a power source 24, such as a battery, generator, etc. which supplies electrical power to the control module. As illustrated in the embodiment of FIG. 1 the power source 24 can be incorporated into the control module. As illustrated in the other embodiments of FIGS. 2 and 3 the power source 24 is located external of the control module 10 and connectable thereto by various electrical connection devices. A commercial off-the-shelf sonar system 26 and radar system 28 are contained within the control module 10. The systems which are described as being within the control module 10 may not always be completely physically within the control module. For example, the sonar and radar systems include antennae which are physically located outside of the control module and connected to the sonar and radar systems within the control module. Other commercial-off-the-shelf items 30 can also be located with in the control module 10.

A commercial-off-the-shelf auto pilot system 32 is located within the control module and connected to an actuator 34 which control the navigation of the marine vessel. A commercial-off-the-shelf network switch 36 enables the auto pilot 32 to communicate with the navigation devices. A PC-NMEA (Personal Computer-National Marine Electronics Association) interface 38 permits communications between PCs and marine electronics. The network switch 36 is connected to the PC-NMEA interface 38. A line of sight LOS or satellite communication modem 40 provides wireless communication between the control module 10 and an individual or other device located remote of the marine vessel.

Also located within the control module 10 are an embedded GPS system 42, an embedded compass 44, a mass storage device 46, communication ports 48 and an embedded microcontroller 50. These devices can be located on a single board, as illustrated, or on separate boards. The microcontroller 50 coordinates and operates all the components of the control module 10 and the devices connected thereto. The microcontroller also enables communication between the control module 10 and an individual or device located remote from the control module.

A plurality of inputs are connected to the control module. A wireless input 52 is in communication with the LOS or SAT corn modem 40. The wireless input can be in communication with a communication gateway 54 which in turn is in communication with a public or private switched telephone network (PSTN) 56. The PSTN is in communication with a personal computer (PC), a personal digital assistant (PDA), a modem of a desk top computer and/or any other device 58 which can provide communication between an individual or device and the control module 10. The individual or device utilizes a user control interface 60 to communicate with the PC, PDA, modem, etc. 58.

Alternatively, a line of sight communication device, such as a wireless transceiver, etc. or satellite communication modem can also be connected wirelessly to the control module 10. The LOS or satellite communication module 60 can also be in communication with a personal computer (PC), a personal digital assistant (PDA), a modem of a desk top computer and/or any other device 62 which can provide communication between an individual or device and the control module 10. The satellite communication module 60 can be in communication with a satellite phone located anywhere on the earth. The satellite communication modem 60 can also be connected to any type of phone or other device which utilizes a satellite for communication. The individual or device utilizes a user control interface 64 to communicate with the PC, PDA, modem, etc. 62. Also the control module 10 can be manually operated by a manual control 66.

The communication ports 48 of the control module 10 enable external devices 68 to communicate with the control module 10. In addition, removable storage media 70 can be connected to or in communication with the mass storage device 46 within the control module 10.

In an alternative embodiment of the present invention illustrated in FIG. 2, the power source 24 is located outside of the control module 10. In addition, a commercial-off-the-shelf (COTS) bus expansion 72 is employed in place of the COTS network switch 36 of the embodiment illustrated in FIG. 1. Also in this embodiment of FIG. 2, the line of sight and/or satellite communication modem 40 is incorporated into the embedded chip portion of the control module.

In another alternative embodiment of the present invention, illustrated in FIG. 3, the power source 24 is located outside of the control module. A commercial-off-the-shelf (COTS) bus expansion 72 is employed in place of the COTS network switch 36 of the embodiment illustrated in FIG. 1. Also in this third embodiment of FIG. 3, the line of sight and/or satellite communication modem 40 is separate from the embedded chip portion of the control module similar to the embodiment of FIG. 1.

FIG. 5 illustrates a control module in the form of a water tight/resistant container 74. The container 74 is preferably hinged, as illustrated, but can also assume other forms such as two halves that connect together with the control module and electrical components contained therein. The container can be in the shape of a sphere with two or more portions that connect to each other to form the container 74 with the control module 10 and electrical components contained therein. In another embodiment, a plurality of individual components of various shapes are connected to each other to form a watertight/resistant container that contains the control module 10 and electrical components. Various connectors 78 are provided on the exterior of container 74. The connectors enable devices such as elements 34, 66, 68, and 70, illustrated in FIG. 1-3, to connect to the control module 10.

FIG. 6 is another view of the control module illustrated in FIG. 5. The various components of the control module illustrated in FIGS. 1-3 are positioned with in the container 74. FIG. 6 illustrates a satellite phone 76 which is connected to the satellite communication modem 40 within the control module.

Utilizing the line of sight communication system, a lap top computer or other similar device could be used to control the marine vessel. The computer would communicate with the onboard autopilot system to control the navigation of the marine vessel. Any type of control device, such as a PDA, a joy stick, preprogrammed command software, etc. could be used to communicate with the onboard autopilot. The autopilot system or other device can also communicate data or information from the marine vessel to the individual or device, thus enabling two way communications. These types of control systems enable an individual or other device to maintain “live” control of the marine vessel.

A control program can also be transmitted via satellite phone to the onboard autopilot system. Since the transmission rate of the satellite phone is not sufficient to enable two way communications, only one way communication via a satellite phone is possible. Therefore only preprogrammed navigational paths or instructions can be transmitted to the onboard autopilot system of the marine vessel utilizing a satellite phone.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

I claim:

1. A marine vessel control system comprising:
a marine propulsion system attached to and driving said marine vessel;
a control system controlling the operation and navigation of said marine vessel;
a plurality of devices in signal communication with said control system, said plurality of devices receiving information regarding the navigation of said marine vessel;
a control module in signal communication with said control system; and
an embedded microcontroller in signal communication with said control module, said microcontroller receiving information regarding the location of said marine vessel and controlling the operation of said marine vessel, said microcontroller enabling communication between said control module and a device located remote from said control module.

2. The marine vessel control system of claim 1 wherein said control system is a commercial off the shelf auto pilot control system for a marine vessel.

3. The marine vessel control system of claim 1 including a wireless communication input in signal communication with said embedded microcontroller, said wireless communication input is in signal communication with one of a line of sight communication modem, a satellite communication modem or a communication gateway.

4. The marine vessel control system of claim 3 wherein said embedded controller is in communication with one of a personal computer, a personal digital assistant, a laptop computer or a desktop computer through said communication gateway.

5. The marine vessel control system of claim 3 wherein said embedded controller is in communication with one of a personal computer, a personal digital assistant, a laptop computer or a desktop computer through said line of sight communication modem.

6. The marine vessel control system of claim 3 wherein said embedded controller is in communication with one of a personal computer, a personal digital assistant, a laptop computer or a desktop computer through said satellite communication modem.

7. The marine vessel control system of claim 1 including a device enabling ZigBee communications between said control module and said device located remote from said control module.

8. The marine vessel control system of claim 1 wherein said control module is in communication with a self contained power source which is separate from a power source of said marine vessel

9. The marine vessel control system of claim 1 including a mass storage device with readily removable media for storing data in communication with said embedded microcontroller.

10. A control system for a marine vessel comprising:
a control system for controlling the operation and navigation of a marine vessel;
a plurality of devices in signal communication with said control system, said plurality of devices receiving information regarding the navigation of a marine vessel;
a control module in signal communication with said control system; and
an embedded microcontroller in signal communication with said control module, said microcontroller receiving information regarding the location of a marine vessel and controlling the operation of said a marine vessel, said microcontroller enabling communication between said control module and a device located remote from said control module.

11. The control system of claim 10 wherein said control system is a commercial off the shelf auto pilot control system for a marine vessel.

12. The control system of claim 10 including a wireless communication input in signal communication with said embedded microcontroller, said wireless communication input is in signal communication with one of a line of sight communication modem, a satellite communication modem or a communication gateway.

13. The control system of claim 12 wherein said embedded controller is in communication with one of a personal computer, a personal digital assistant, a laptop computer or a desktop computer through said communication gateway.

14. The control system of claim 12 wherein said embedded controller is in communication with one of a personal computer, a personal digital assistant, a laptop computer or a desktop computer through said line of sight communication modem.

15. The control system of claim 12 wherein said embedded controller is in communication with one of a personal computer, a personal digital assistant, a laptop computer or a desktop computer through said satellite communication modem.

16. The control system of claim 10 including a device enabling ZigBee communications between said control module and said device located remote from said control module.

17. The control system of claim 10 wherein said control module is in communication with a self contained power source which is separate from a power source of a marine vessel

18. The control system of claim 10 including a mass storage device with readily removable media for storing data in communication with said embedded microcontroller.
